(19) United States
(12) Patent Application Publication
(10) Pub. No.: US 2010/0036949 A1
(43) Pub. Date: Feb. 11, 2010

(54) Centralized Scheduler for Content Delivery Network

(76) Inventors: Jun Li, Cranbury, NJ (US); Snigdha Verma, Somerset, NJ (US); Kumar Ramaswamy, Princeton, NJ (US)

Correspondence Address: Joseph J Laks;Thomas Licensing, P.O Box 5312, Princeton, NJ, 08543-5312, US

(21) Appl. No.: 12/224,680

(22) PCT Filed: Mar. 28, 2006
(86) PCT No.: PCT/US2006/011044

§ 371 Date: Oct. 1, 2009

(51) Int. Cl. G06F 15/173

(52) U.S. Cl. 709/225

(57) ABSTRACT

A method for performing centralized scheduling of content delivery is described including performing admission control, locating a server that is a source of content, determining a content delivery schedule and reordering the content delivery schedule over a content delivery network (CDN). Also described is a method for performing admission control including reordering a request queue based on partially served committed requests for content and newly arrived requests for content and determining if the newly arrived request for content can be admitted to the request queue.

### FIELD OF THE INVENTION

The present invention relates to a content delivery network (CDN) to provide delayed downloading services. More particularly, the present invention relates to a centralized scheduler for a content delivery network.

### BACKGROUND OF THE INVENTION

The prior art describes a scheduling algorithm for a single content server and a single cache server for delayed downloading services. Content delivery network (CDN) technology is typically used for a service that can render the requested content at a later time, delayed from the request time. Digital movie rental service can be a typical service of such.

CDN technology includes two key components: (1) allocate resource to distribute content to edge servers and (2) redirect a request (request-routing) to distribute content from an edge server to a client. In conventional CDN networks, request-routing is made to an edge server only if the content is available at the edge server.

### SUMMARY OF THE INVENTION

The present invention describes a centralized scheduler for a content delivery network with cache/edge servers to achieve (1) traffic load balancing by selecting distribution paths and (2) traffic load smoothing by selecting distribution schedules at a centralized controller.

In the CDN of the present invention, request-routing can be made to an edge server even if the content is not yet available at an edge server. The ability to select a path of servers, which can deliver the requested content to the client is the request-routing function for the CDN of the present invention. That is, the centralized scheduler of the CDN of the present invention identifies a path in the CDN, through which the requested content will be distributed—via a request schedule using the centralized scheduler of the present invention.

A method for performing centralized scheduling of content delivery is described including performing admission control, locating a server that is a source of content, determining a content delivery schedule and reordering the content delivery schedule. Also described is a method for performing admission control including reordering a request queue based on partially served committed requests for content and newly arrived requests for content and determining if the newly arrived request for content can be admitted to the request queue.

The present invention defines the scheduling problem of a CDN system for delayed downloading services and proposes a heuristic method for solving the request-routing problem using (1) normalized rate ordering and (2) sequential path selection.

### BRIEF DESCRIPTION OF THE DRAWINGS

FIG. 1 is a schematic diagram of a content delivery network illustrating the problem solved by the present invention.

FIG. 2 is a flowchart depicting the normalized rate earliest delivery (NRED) method of the present invention.

### DETAILED DESCRIPTION OF THE PREFERRED EMBODIMENTS

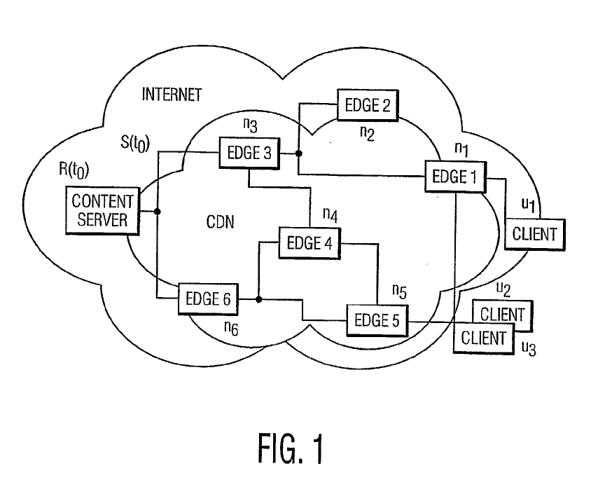

The method of the present invention for optimizing admission and establishing a delivery schedule is based on a centralized approach. The CDN of the present invention supports delayed downloading services that can be generalized as the problem depicted in FIG. 1, which is a schematic diagram of a content delivery network illustrating the problem solved by the present invention.

FIG. 1 shows the internet overlaid by a CDN having a content server, a plurality of clients/users uᵢ, and a plurality of edge servers from which content is received by the users/clients. The content server receives a request for routing (request-routing R(t₀)) content to a client via an edge server at some future time. The edge server may not as yet have the requested content available. The centralized scheduler (resident in the content server) must find/determine a scheduling set S(t₀) such that the requested content is available for the client that requested the content at or before the requested time of delivery. The centralized scheduler must take into account other pending requests for content as well as the link status B((nᵢ,nⱼ),t) and link capacity b((nᵢ,nⱼ),t) and the caching status Cᵢ(t) and caching capacity cᵢ(t).

The parameters used in performing centralized scheduling in accordance with the present invention are as follows:

N={nⱼ, j=0, . . . , J}—network node set, including a content server (j=0), I edge servers (j=1, . . . , I) and U clients (j=I+1, . . . , I+U=J).
At each node, there is a cache,
cᵢ(t)—the caching capacity, cᵢ if cache size if fixed
Cᵢ(t)—the set of cache status at time t,—list of cached content.
   L={(nᵢ, nⱼ), nᵢ_{_{—}}nⱼεN}—network link set, where (nᵢ,nⱼ) is the link from node nᵢ to node nⱼ, the link capacity can be time-varying.
b((nⱼ,nₖ),t)—the link capacity, b(nᵢ,nⱼ), if link capacity is a constant.
B((nⱼ,nₖ),t)—the link status of (nᵢ,nⱼ) at time t,—list of transmitting content.
   The CDN network is defined as [N, {cⱼ(t)},{b((nⱼ,nₖ),t)}] comprised by a node set with caches and links.
R(t₀)={(r_{q},q=1 . . . Q}—the request set, represents all requests made by clients to the content server at time t=t₀.
   r_{q}=(m_{q}, d_{q}, u_{q})—a request is represented by content ID, due time and request client ID.
   m_{q}—content ID with a content size |m_{q}| and a real-time streaming rate as ∥m_{q}∥.
   d_{q}—due time for request r_{q}
   u_{q}—the client ID for the client which made the request, from which the geographical location can be identified.
      S(t₀)={s_{q}(nᵢ,nⱼ), all (nᵢ,nⱼ)εL}—the scheduling set for the request set R(t₀),
   s_{q}(nᵢ,nⱼ)—the schedule (starting) time for request r_{q} to be transported on link (nᵢ,nⱼ) at the streaming rate ∥m_{q}∥.

The optimization problem to be solved by the present invention is that given a request set, a scheduling set must be determined. At any time a new request arrives, the scheduling set must be determined that permits the fastest distribution of the requested content. The problem can be defined as follows:

Given a network [N, {cⱼ(t)},{b((nⱼ,nₖ),(t)}], a request set R(t₀), and the initial condition of caches {Cᵢ(t₀), i=1 . . . I} and links {B((nⱼ,nₖ),t₀), (nⱼ,nₖ)εL} at time t=t₀, find a scheduling set S(t₀)={s_{q}(nⱼ,nₖ); (nⱼ,nₖ)εL} so that the latest schedule time for all requests on all links is minimized, that is:

Minimize [Max(s_{q}(nⱼ,nₖ); (nⱼ,nₖ)εL & r_{q}εR(t₀))] (1)

### Subject to:

(1) Due time constraints

d_{q}≦max[s_{q}(nⱼ,nₖ),(nⱼ,nₖ)εL] for all r_{q}

(2) Cache constraints at any time t≧t₀,

|Cᵢ(t)|=Σₘ_{_{—}}_{qεCi(t)}|m_{q}|≦cᵢ(t), i=1 . . . I

where |m_{q}| is the size of content for the request r_{q}, and
(3) Link capacity constraints at any time t≧t₀,

l((nⱼ,nₖ),t)=Σₛ_{_{—}}_{q(n}_{_{—}}_{j,n}_{_{—}}_{k)>0}[g(t−s_{q}(nⱼ,nₖ))−g(t−e_{q}(nⱼ,nₖ))]∥m_{q}∥≦b((nⱼ,nₖ),t)

where g[x] is the step function. g[x]=1, x≧0, otherwise g[x]=0, and e_{q}(nⱼ,nₖ)=s_{q}(nⱼ,nₖ)+|m_{q}|/∥m_{q}∥ is the ending time of downloading the content for request r_{q}. It is assumed that the content is delivered in one consecutive time slot at streaming rate.

Although the goal is to serve the whole request set as early as possible, i.e. giving a schedule time as early as possible, for a given request set, there can be many schedules that can satisfy the constraints, which include using different paths and serving the requests in different orders. The complexity of the path selection is O(p^{Q}), where p is the average number of paths between the content server and a client. The complexity of serving/selecting orders can be up to O(Q!) in the extreme case.

The centralized scheduler of the present invention, includes a heuristic method that uses the following definitions/rules:

1) Request ordering:
The requests are queued in a predetermined order. For example, requests can be ordered in arrival order, i.e. first come first served (FIFO) order or in due-time (DT) order. A preferred embodiment is a normalized rate (NR) order, which is explained as follows:
The normalized rate for request r_{q} at time t, which represents a rate that is required to deliver the content for request r_{q} before the due time d_{q} is defined as |m_{q}|/(d_{q}−t). For example, if a request is for a content with size is 4 GB and due time is 8 PM, current time is 4 PM, the normalized rate for the request is 4 GB/4 hours=2.2 Mbps, that is the rate to finish deliver the content before 8 PM starting at 4 PM. If the CDN serves the request set R(t₀) in the order of normalize rate at t=t₀, the probability of a request is over due can be minimized. The complexity of selecting order become O(Q), which is greatly reduced.

2) Sequential path selection:
Although requests are queued in an order, if the path selections for requests must be jointly determined, the complexity is still quite high, i.e. O(p^{Q}). The problem can be greatly simplified by using an alternative goal that seeks a minimum schedule time for each request one by one in the given queuing order, that is for each request r_{q} in R(t₀).

That is, the centralized scheduler of the present invention seeks to

Minimize [Max(s_{q}(nⱼ,nₖ); (nⱼ,nₖ)εL)] (2)

The set of optimal schedules {s_{q}(nⱼ,nₖ), (nⱼ,nₖ)εL} will be determined for each request r_{q} based on the previously made scheduling vectors {sₓ(nⱼ,nₖ); x=0, . . . , q−1}. Since each request seeks the best of its own schedule based on previous conditions, the scheduling decision is made for each request independent of future requests. The complexity becomes O(pQ).

Processing requests sequentially, each request's schedule is made as early as possible. In the normalized order, processing requests sequentially, the schedule is made as early as possible. This method is denoted herein as the normalized rate earliest delivery (NRED) method, which can be best described as follows:
1. List request set R(t₀) as a queue with normalized rate order, still represented as R(t₀). Let the initial condition of caches and links be {Cᵢ(t₀), i=1 . . . I}, {B((nⱼ,nₖ),t₀), (nⱼ,nₖ)εL}, respectively.
2. For (q=0 to Q, q++); Q is the number of total requests received at time t.
3. For request r_{q}=(m_{q}, d_{q}, u_{q}), find the shortest path that provides the minimum schedule time (equation (2)) of the content m_{q} to u_{q}, through the following procedure:
4. Starting from a set of servers H_{q}, in which each server nᵢεH_{q} has the content m_{q}εCᵢ(t_{i,q}), where t_{i,q} is the last time cache on server nᵢ got updated before r_{q} is processed.
5. Using a multi-source shortest path algorithm (such as Dijkstra's algorithm) to find the shortest path from any server nᵢεH_{q} to u_{q}.
6. Find the schedule {s_{q}(nⱼ,nₖ), (nⱼ,nₖ)εL} and update cache {Cᵢ(t_{i,q+1}), nᵢεN} for servers on the shortest path and links {B((nⱼ,nₖ), t_{i,q+1}), (nⱼ,nₖ)εL}, respectively, applying constraints on link capacity and cache capacity.
7. If max[s_{q}(nⱼ,nₖ), (nⱼ,nₖ)εL]>d_{q}, then the method failed to find a scheduling set for R(t₀); The method has failed with the resulting rejection of the latest content request arrival in the request set R(t₀).
8. Continue to next request, step 2.

The metrics for the shortest path algorithm can be defined, for example, as follows:
1) Minimum schedule time: the path that gives the smallest schedule time for a request. This metric is for equation (2).
2) Minimum number of hops: the path that gives the smallest load to the network. This metric may not give the best schedule time for each individual request, but it should give good overall result, which fit equation (1) better.

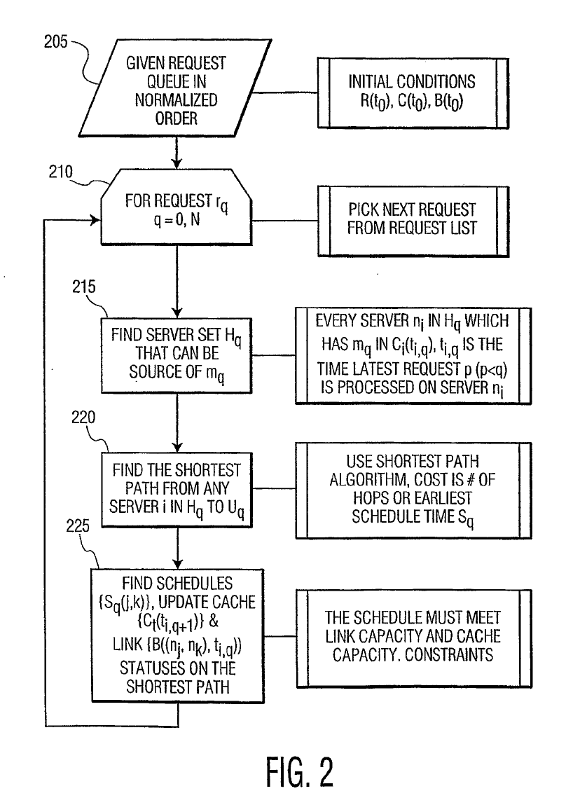

FIG. 2 is a flowchart depicting the normalized rate earliest delivery (NRED) method of the present invention. The request queue has been put in normalized order at 205. The normalized order constitutes the initial conditions. A single request is taken from the request queue at 210 in order. At 215 the server set H that has the requested content is located. The server set includes every server nᵢ that has previously serviced a request for the requested content and which content has not yet been replaced by other content. The shortest path is then determined at 220 from any server nᵢ in the server set H to the user/client uᵢ (via an edge server). The cost for the shortest path is the number of hops or the earliest schedule time. At 225 the schedules, cache status and cache capacity for all links and servers on the shortest path are determined. The schedules must also meet link capacity and link status.

For a given CDN topology and a set of partially served requests for content and new requests for content, the request queue is reordered based on partially served committed requests and newly arrived requests. This procedure is called admission control. New requests for content are admitted if possible (resources permitting). Specifically, a centralized server determines if a new request for content can be admitted. The centralized scheduler of the present invention determines if a schedule can be developed that satisfies the new request for content without dropping an already admitted request. This determination is made by emulating the service of the partially served committed requests along with the newest request taken from the normalized request queue. A new request for content is rejected and removed from the request queue if no such schedule can be developed.

The centralized server of the present invention sends commands to edge servers and clients/users to invoke the downloading processes according to the schedules developed in satisfaction of the newest request for content admitted.

In an alternative embodiment, the method of the present invention can also use striping as long as each striped unit of content is defined as a single unit of content. A request for striped content can be made using multiple requests, one for each striped unit and each with optionally some pro-rated due time. While this increases the overall complexity of the method, it may also result in units of content delivered faster and perhaps even in parallel.

The method of the present invention (NRED) thus temporally and spatially smoothes the loads in a content distribution network and thereby delivers more requested content on time. Since content requests are often bursty (often coming at peak hours and from hotspots), without scheduling the content distribution network can be overloaded during some time periods and unused during other time periods.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for controlling admission to a request queue, said method comprising:
reordering said request queue based on partially served committed requests for content and newly arrived requests for content; and
determining if said newly arrived request for content can be admitted to said request queue.

2. The method according to claim 1, wherein said determining, step further comprises emulating service of said partially served committed requests for content and said newly arrived requests for content.

3. The method according to claim 2, wherein said newly arrived request for content is a next sequential request taken from said reordered request queue.

4. A method for performing centralized scheduling of content delivery over a content delivery network, said method comprising:
performing admission control;
locating a server that is a source of content;
determining a content delivery schedule; and
reordering said content delivery schedule.

5. The method according to claim 4, further comprising executing said reordered content delivery schedule.

6. The method according to claim 4, wherein said reordering step further comprises optimizing said content delivery schedule.

7. The method according to claim 6, further comprising:
calculating a normalized rate for each unit of content scheduled for delivery; and
reordering said content delivery schedule based on said calculated normalized rates.

8. The method according to claim 7, wherein each of said normalized rates is a size of said unit of content divided by a content delivery due time less a current time.

9. The method according to claim 4, wherein said determining step further comprises sequential path selection for said content delivery network.

10. The method according to claim 9, wherein sequential path selection is the selection of a path from a content server to a client requesting said content by minimizing schedule time for each request for content sequentially n normalized order.

11. The method according to claim 4, wherein said content delivery schedule is determined by sequentially determining a minimum number of hops in a path from a content server to a client requesting said content for each request for content in a request queue.
